(19) United States
(12) Patent Application Publication
(10) Pub. No.: US 2013/0216412 A1
(43) Pub. Date: Aug. 22, 2013

(54) FIXING APPARATUS FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/425,396

(22) Filed: Mar. 20, 2012

(30) Foreign Application Priority Data
Feb. 20, 2012 (CN) 201210038119.9

(51) Int. Cl. F04D 29/60; F16M 13/00

(52) U.S. Cl. 417/423.15; 248/674

(57) ABSTRACT

A fixing apparatus for a fan includes a bottom wall, and a fixing member for fixing the fan. The bottom wall forms two fixing portions and a block. The fixing member includes a plate defining a through hole, and a latch extending from a side of the board. The through hole includes a first hole and a second hole communicating with the first hole. The second hole is less than the first hole in size. A blocking piece perpendicularly extends up from a distal end of the latch. The fixing member is slidably mounted to the bottom wall, and the fixing portion extends through the first hole and then engages in the second hole. The blocking piece is blocked by a rear surface of the block.

### CROSS-REFERENCE OF RELATED APPLICATIONS

Relevant subject matter is disclosed in two pending U.S. patent applications, all titled “FIXING APPARATUS FOR FAN”, respectively filed on Feb. 29, 2012, Mar. 6, 2012, and Mar. 19, 2012, with the application Ser. Nos. 13/407,780, 13/413,545, and 13/423,296, which are assigned to the same assignee as this patent application.

### BACKGROUND

1. Technical Field

The present disclosure relates to an apparatus for fixing a fan.

2. Description of Related Art

Large electronic devices use fans to cool electronic components. In related art, a fan is mounted in the electronic device by a plurality of screws, which makes it difficult and time-consuming to replace or remove the fan for repair.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a fixing apparatus together with a number of fans.

FIG. 2 is an enlarged view of the circled portion II of FIG. 1.

FIG. 3 is a partly assembled, isometric view of the fixing apparatus of FIG. 1.

FIG. 4 is an assembled, isometric view of the fixing apparatus of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

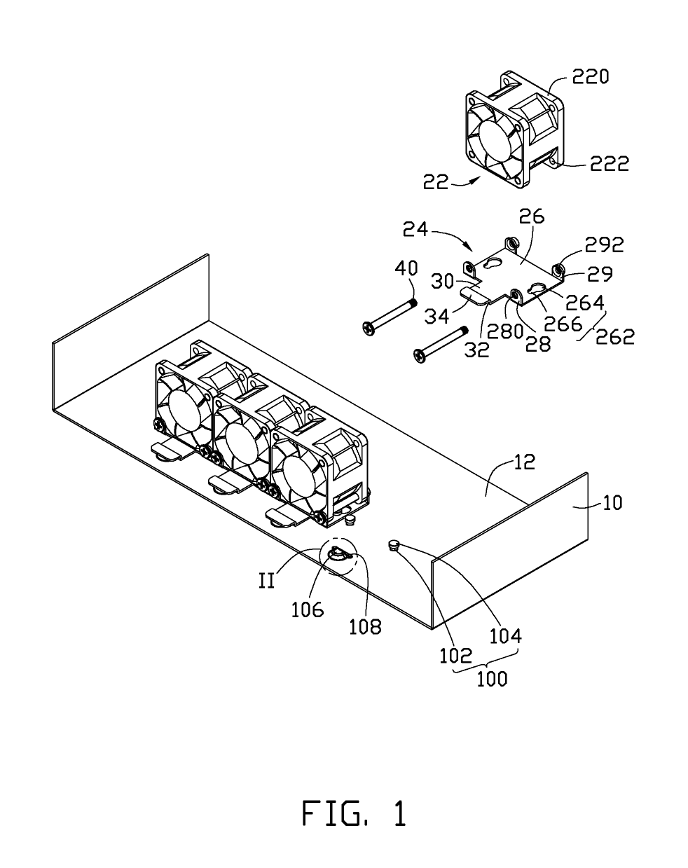

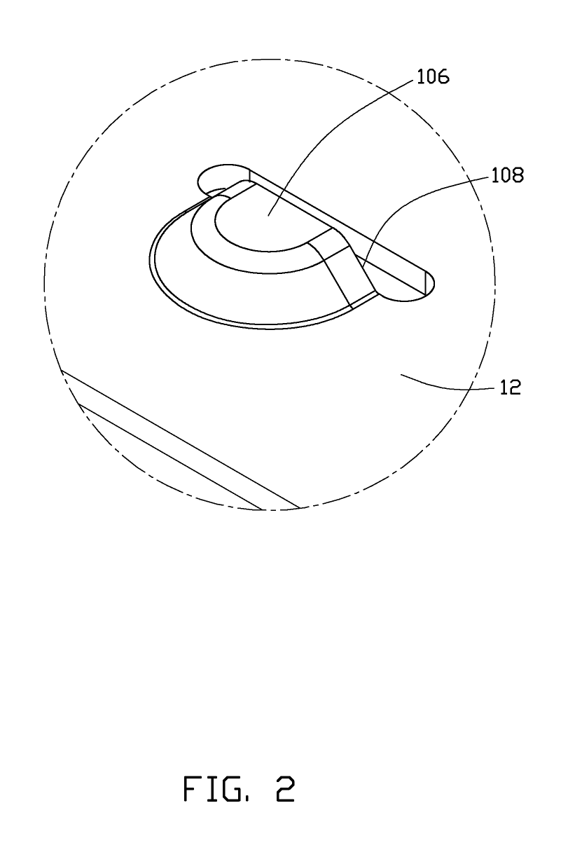

Referring to FIGS. 1 and 2, an exemplary embodiment of a fixing apparatus for a fan 22 includes a chassis 10 and a fixing member 24 detachably mounted in the chassis 10. The fan 22 has a flat front-facing surface and a flat rear-facing surface (together referred to as spaced boards 220). Each board 220 defines two corner holes 222 in a lower portion of the board 220.

The chassis 10 includes a bottom wall 12. Two fixing portions 100 are formed on the bottom wall 12. Each fixing portion 100 includes a neck 102 perpendicularly extending up from the bottom wall 12, and a head 104 formed on a top end of the neck 102 opposite to the bottom wall 12. The diameter of the head 104 is substantially greater than the diameter of the neck 102. A block 106 is formed on the bottom wall 12, at a side of the fixing portions 100. A rear surface 108 of the protrusion 106 is substantially perpendicular to the bottom wall 12.

The fixing member 24 includes a rectangular plate 26, two first protrusions 28 extending up from a front side of the plate 26, two second protrusions 29 extending up from a rear side of the plate 26, and a latch 30 extending out from the front side of the plate 26 between the first protrusions 28. Two through holes 262 are defined in the plate 26. The distance between the two through holes 262 is equal to the distance between the two fixing portions 100. Each through hole 262 includes a first hole 264 away from the latch 30, and a second hole 266 communicating with the first hole 264 and adjacent to the latch 30. The size of the first hole 264 is greater than the size of the second hole 266. Each first protrusion 28 defines a through hole 280. Each second protrusion 29 defines a threaded hole 292. A blocking piece 32 perpendicularly extending up from a distal end of the latch 30 opposite to the plate 26. An operation portion 34 perpendicularly extending out from a top end of the blocking piece 32 away from the plate 26.

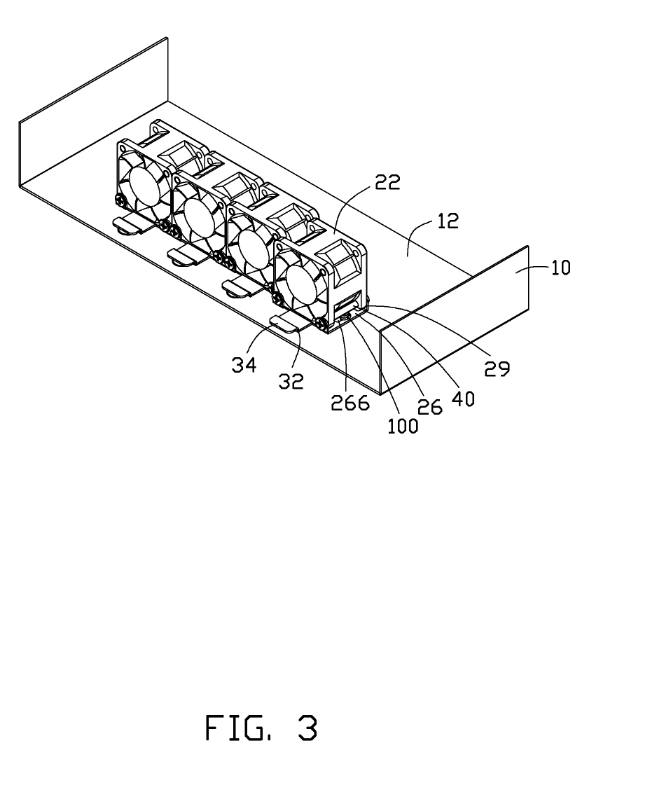

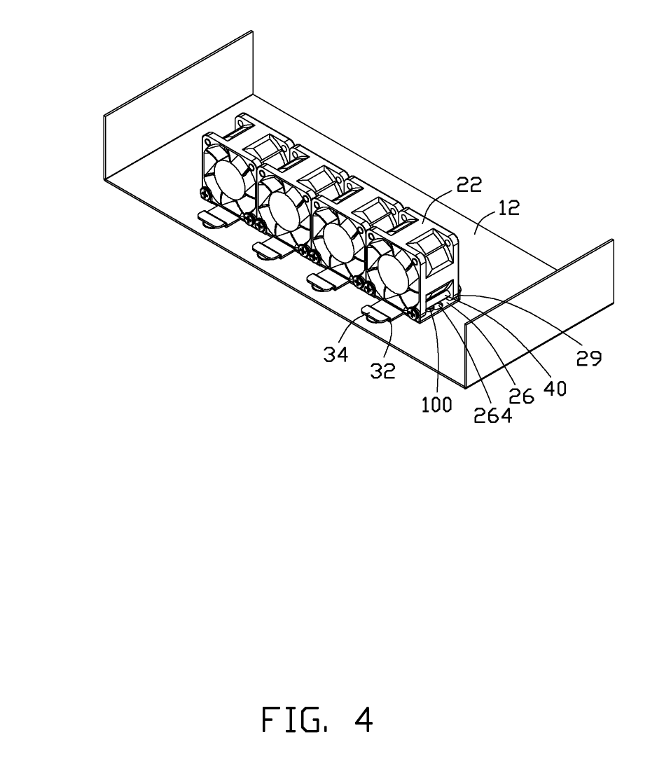

Referring to FIGS. 3 and 4, in assembling the fan 22 to the fixing member 24, the fan 22 is attached to the fixing member 24. The spaced boards 220 are supported on the plate 26. The lower portion of one of the boards 220 abuts against inner surfaces of the first protrusions 28, and the corner holes 222 are respectively aligned with the through holes 280. The lower portion of the other one of the boards 220 abuts against inner surfaces of the second protrusions 29, and the corner holes 222 are respectively aligned with the threaded holes 292. Two fasteners 40 respectively extend through the through holes 280 and the corresponding corner holes 222, and then are engaged in the corresponding threaded holes 292.

In installing the fixing member 24 to the chassis 10, the fixing member 24 is put on the bottom wall 12. The first holes 264 are manipulated over the fixing portions 100. The latch 30 is deformably abutted against a top of the block 106. The fixing member 24 is then slid rearward to allow the necks 102 of the fixing portions 100 enter the second holes 266, the heads 122 of the fixing portions 100 abut the top surface of the plate 26 and are thus captive. The latch 30 is then pressed down with finger pressure; therefore, the blocking piece 32 is blocked by the rear surface 108.

In uninstalling the fixing member 24 together with the fan 22, the operation portion 34 is deformed upward with finger pressure, to disengage the blocking piece 32 from the rear surface 108. Therefore, the fixing member 24 together with the fan 22 can be slid forward to disengage the first portions 100 from the second holes 266.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing apparatus for fixing a fan having two spaced boards, comprising:
a bottom wall forming two fixing portions and a block; and
a fixing member comprising a plate to fix the fan, and a latch extending out from a first side of the plate, the plate defining two first through holes each having a first hole and a second hole communicating with the first hole, wherein a size of the first hole is greater than a size of the second hole; a blocking piece perpendicularly extends up from a distal end of the latch opposite to the plate;
wherein the fixing member is slidably mounted on the bottom wall, the fixing portions are respectively extended through the first holes and then respectively engaged in the corresponding second holes, the blocking piece is blocked by a rear surface of the block.

2. The fixing apparatus of claim 1, further comprising two fasteners, wherein two first protrusions extend up from the first side of the plate, two second protrusions extend up from a second side of the plate opposite to the first side, each first protrusion defines a second through hole, each second protrusion defines a threaded hole, the fasteners respectively extend through the second through holes and the boards of the fan to engage in the corresponding threaded holes.

3. The fixing apparatus of claim 1, wherein the rear surface of the block is substantially perpendicular to the bottom wall.

4. The fixing apparatus of claim 1, wherein an operation portion perpendicularly extending out from a top of the blocking piece away from the plate.

5. The fixing apparatus of claim 1, wherein each fixing portion comprises a neck extending from the bottom wall and a head extending from a top end of the neck opposite to the bottom wall, a diameter of the head is greater than a diameter of the neck, the head of the fixing portion is blocked by a top surface of the plate in response to the neck entering the corresponding second hole.

6. The fixing apparatus of claim 1, wherein the first hole is away from the latch, the second hole is adjacent to the latch.

7. A fan assembly, comprising:
a bottom wall forming two fixing portions and a block;
a fan; and
a fixing member comprising a plate to fix the fan, and a latch extending out from a first side of the plate, the plate defining two first through holes each having a first hole and a second hole communicating with the first hole, wherein a size of the first hole is greater than a size of the second hole; a blocking piece perpendicularly extends up from a distal end of the latch opposite to the plate;
wherein the fixing member is slidably mounted on the bottom wall, the fixing portions are respectively extended through the first holes and then respectively engaged in the corresponding second holes, the blocking piece is blocked by a rear surface of the block.

8. The fan assembly of claim 6, further comprising two fasteners, wherein the fan comprises two opposite spaced boards, each board defines two corner holes in a lower side of the board, two first protrusions extend up from the first side of the plate, two second protrusions extend up from a second side of the plate opposite to the first side, each first protrusion defines a second through hole, each second protrusion defines a threaded hole, the fasteners respectively extend through the second through holes, the corresponding corner holes to engage in the corresponding threaded holes.

9. The fan assembly of claim 6, wherein the rear surface of the block is substantially perpendicular to the bottom wall.

10. The fan assembly of claim 6, wherein an operation portion perpendicularly extending out from a top of the blocking piece away from the plate.

11. The fan assembly of claim 6, wherein each fixing portion comprises a neck extending from the bottom wall and a head extending from a top end of the neck opposite to the bottom wall, a diameter of the head is greater than a diameter of the neck, the head of the fixing portion is blocked by a top surface of the plate in response to the neck entering the corresponding second hole.

12. The fan assembly of claim 6, wherein the first hole is away from the latch, the second hole is adjacent to the latch.
